(19) United States
(12) Patent Application Publication
(10) Pub. No.: US 2015/0149963 A1
(43) Pub. Date: May 28, 2015

(54) METHOD AND APPARATUS FOR PROVIDING A USER INTERFACE FOR USE IN SELECTING AN AMOUNT TO BE TRANSACTED BY A USER OF AN AUTOMATED TELLER MACHINE

(71) Applicant: Nautilus Hyosung Inc., Seoul (KR)

(72) Inventors: Boick CHANG, Seongnam-si (KR); Woo Jae SUNG, Seongnam-si (KR)

(21) Appl. No.: 14/328,450

(22) Filed: Jul. 10, 2014

(30) Foreign Application Priority Data
Nov. 27, 2013 (KR) 10-2013-0145682

(51) Int. Cl. G06F 3/0484; G06Q 20/10; G06Q 20/18; G06F 3/0488

(52) U.S. Cl. CPC G06F 3/04847; G06F 3/0488; G06Q 20/1085; G06Q 20/18
USPC 715/833

(57) ABSTRACT

A method and apparatus is disclosed for providing a user interface for use in selecting an amount to be transacted by a user of an automated teller machine (ATM). The user interface comprises an input unit for receiving a user input associated with a sliding gesture, and an output unit for displaying a selected amount determined based on the user input associated with the sliding gesture, to thereby provide a user interface for selecting an amount of money in an intuitive manner.

### CROSS-REFERENCE TO RELATED APPLICATION

This application claims priority under 35 U.S.C. §119(a) to Korean Patent Application No. 10-2013-0145682 filed on Nov. 27, 2013, which is incorporated by reference herein in its entirety.

### FIELD OF THE INVENTION

The present invention relates to a method and apparatus for providing a user interface for use in selecting an amount of money to be transacted by a user of an automated teller machine (ATM) and a computer-readable recording medium for storing instructions that implement such method and apparatus.

### BACKGROUND OF THE INVENTION

Generally, automated teller machines (ATMs) are provided to perform various transactions for users having bank accounts, such as deposit transactions, withdrawal transactions, transfer transactions, and the like. In the process of such transactions using an ATM, a user may select an amount of money to be transacted by the ATM. For example, the user may input a withdrawal amount when he or she wants to withdraw money from a certain account, and may input a transfer amount when he or she wants to transfer money from one account to another.

In order to facilitate the user's selection of an amount of money to transact, conventional ATMs provide the user with several predetermined amounts in the form of buttons on the touch screen of the ATM, thereby the number of amounts of money selectable by the user is limited depending on the number of buttons displayed on the touch screen. In case when the user wants to select an amount that is not displayed on the screen, an extra user interface is needed for the user to directly enter the amount that he wants to transact. For example, assume that a user interface of an ATM provides 10 buttons respectively corresponding to values $20, $40, $60, $80, $100, $140, $200, $300, $400, and $500, whereas the user wants to select $160. In that case, an extra user interface (e.g., a number pad) needs to be invoked, and then the user may directly input the desired amount, i.e., $160, by using the extra user interface.

### SUMMARY OF THE INVENTION

It is, therefore, an object of the present invention to provide user interfaces for selecting an amount of money to be transacted in an intuitive manner.

In accordance with one embodiment of the present invention, there is provided an apparatus for providing a user interface for use in selecting an amount to be transacted by a user of an automated teller machine (ATM). The user interface comprises an input unit for receiving a user input associated with a sliding gesture, and an output unit for displaying a selected amount determined based on the user input associated with the sliding gesture.

In accordance with one embodiment of the present invention, the input unit includes a track marked with a plurality of amount indicators and a slider movable along the track by the user input associated with the sliding gesture, and the selected amount is determined based on a position of the slider on the track.

In accordance with another embodiment of the present invention, the input unit includes a rotator marked with a plurality of amount indicators, the rotator being rotated by the user input associated with the sliding gesture, and the selected amount is determined based on a degree of rotation of the rotator.

In accordance with yet another embodiment of the present invention, the input unit includes a tape marked with a plurality of amount indicators, the tape being shifted by the user input associated with the sliding gesture, and the selected amount is determined based on a degree of shift of the tape.

In accordance with one embodiment of the present invention, there is provided a method for providing a user interface for use in selecting an amount to be transacted by a user of an automated teller machine (ATM). The method comprises the steps of providing an input unit and an output unit, receiving, by the input unit, a user input associated with a sliding gesture, determining a selected amount based on the user input associated with the sliding gesture, and displaying the selected amount on the output unit.

### BRIEF DESCRIPTION OF THE DRAWINGS

FIG. 1 presents an exemplary ATM that provides a user interface for use in selecting an amount of money to be transacted in accordance with embodiments of the present invention.

FIG. 2 illustrates a user interface for use in selecting an amount of money to be transacted by a user of an ATM in accordance with one embodiment of the present invention.

FIG. 3 depicts the user interface as shown in FIG. 2, in which a slider is moved and stopped at a certain position on a track.

FIG. 4 describes an exemplary implementation of the user interface as shown in FIGS. 2 and 3, in which the track is divided into a movable area and an unmovable area.

FIG. 5 shows a user interface for use in selecting an amount of money to be transacted by a user of an ATM in accordance with another embodiment of the present invention.

FIG. 6 illustrates a user interface for use in selecting an amount of money to be transacted by a user of an ATM in accordance with yet another embodiment of the present invention.

FIG. 7 presents a flow diagram describing an exemplary process of withdrawing cash by using an ATM in accordance with an embodiment of the present invention.

FIG. 8 provides a flow diagram showing an exemplary method for providing a user interface for use in selecting an amount to be transacted by a user of an ATM in accordance with an embodiment of the present invention.

### DETAILED DESCRIPTION OF THE EMBODIMENTS

Hereinafter, embodiments of the present invention will be explained in detail with reference to the attached drawings.

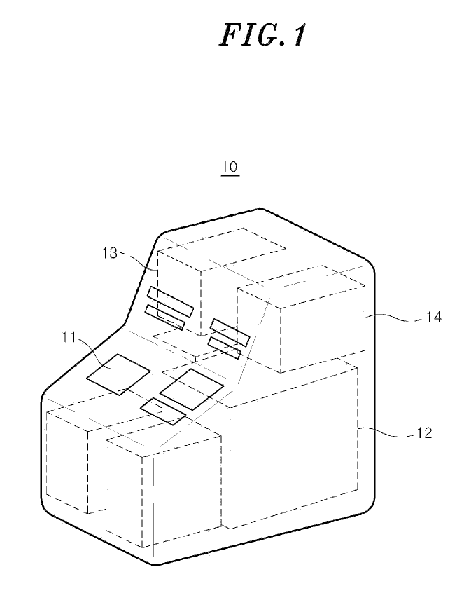

FIG. 1 presents an exemplary ATM that provides a user interface for use in selecting an amount of money to be transacted in accordance with embodiments of the present invention.

It will be understood that an ATM 10 may be a common automated teller machine, a cash dispenser (CD) that provides a service of withdrawing cash, an automatic multi-functional machine that provides various financial services associated with banks, insurance companies, credit cards, and the like, other type of automatic machine, for example, a kiosk that provides various supplementary services including receiving utility bills, issuing tickets, saving points, and the like, and a portable device, such as a smartphone that provides phone banking services.

The ATM 10 may include a user interface unit 11, a banknote unit 12, a bankbook unit 13, and a card reader 14.

The user interface unit 11 provides a user with various financial services or supplementary services by using a graphic user interface (GUI). Further, the user interface unit 11 includes, but not limited to, an interface in the form of a touch screen for receiving a manipulation and a selection by the user from a menu displayed on the touch screen, an interface in the form of buttons for receiving a manipulation and a selection by the user from a menu provided by the buttons, or the combination of the touch screen and the buttons.

The banknote unit 12 collects, exports, counts, and stores banknotes, and the bankbook unit 13 reads and updates a bankbook. The card reader 14 reads a credit or debit card when the user inserts the credit or debit card into the ATM, and processes a transaction associated with such card. The card reader 14 may read different types of cards, such as a point card, an identification card, and the like, as well as the credit or debit card. In addition, the ATM 10 may additionally include, but not limited to, a communication unit for providing access to a server of a financial institution, a control unit for controlling general operations of the ATM, a memory storing various pieces of data, a printing module for printing a bankbook or an itemized account, and the like.

It will be understood that the term “transaction” as used herein refers to a business or a service that can be carried out by an ATM for a holder of a financial account, including deposit, withdrawal, transfer, balance inquiry, and so on.

An amount of money to be transacted may be selected by a user of an ATM. For example, when the user wants to withdraw money from the ATM, the user may select an amount of money he or she wants to withdraw. Embodiments of the present invention provide user interfaces in which the desired amount is easily selectable by the user.

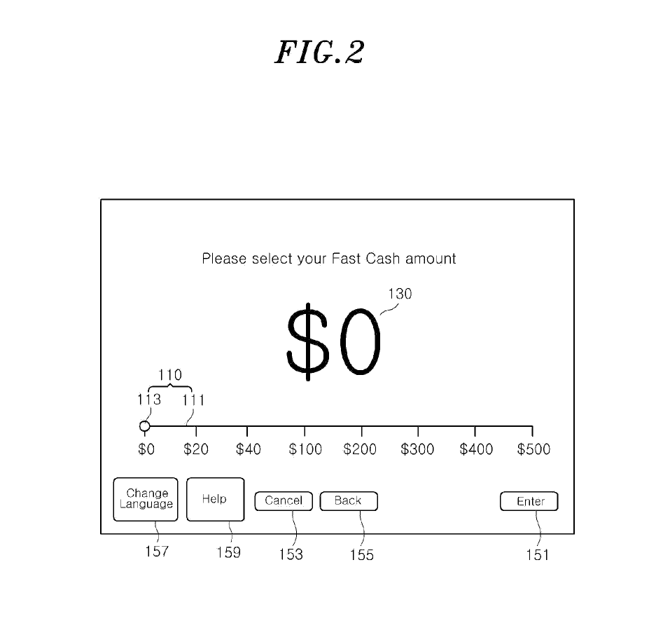

Hereinafter, the user interfaces for use in selecting an amount to be transacted by a user of an ATM will be explained in accordance with various embodiments of the present invention with reference to FIGS. 2 to 6.

FIG. 2 illustrates a user interface provided by the ATM in accordance with one embodiment of the present invention. The user interface of the ATM in accordance with one embodiment of the present invention comprises an input unit 110 and an output unit 130.

Referring to FIG. 2, the input unit 110 and the output unit 130 can be implemented as parts of a graphic user interface (GUI) displayed on a touch screen. Alternatively, unlike FIG. 2, the input unit 110 and the output unit 130 may be respectively displayed on at least two different touch screens. Further, the input unit 110 may be displayed on a touch screen while the output unit 130 may be displayed on other means for display. Further, the input unit 110 is not limited to the graphic user interface displayed on the touch screen, but may be a separate component coupled to the ATM, such as a scroll device.

The input unit 110 receives a user input. The user input may be associated with a sliding gesture. The sliding gesture may be associated with a sliding motion of a part of a human body (e.g., the user's finger) or of other objects that are not a part of a human body (e.g., a stylus). Further, the sliding gesture may be associated with a touchless motion of the user (e.g., a hand motion) recognized by a sensor, such as a camera.

The selected amount is determined based on the user input received at the input unit 110. The selected amount is then displayed on the output unit 130

As illustrated in FIG. 2, the input unit 110 includes a track 111 marked with a plurality of amount indicators and a slider 113 which is movable along the track 111 by the user input. In this example, the plurality of amount indicators respectively correspond to predetermined values (i.e., $0, $20, $40, $100, $200, $300, $400, and $500).

The user input may be associated with a sliding gesture. For example, the slider 113 may be dragged along the track 111 by the movement of the user's finger in contact with the input unit 110. The slider 113, of course, may be moved when the user touches or pushes a point on the track 111 (e.g., a certain position on the track 111 from the slider 113 separated at least by a predetermined distance). Further, other elements in the form of buttons (e.g., arrow shaped buttons) may be added in the vicinities of both ends of the track 111 such that the user can move the slider 113 by touching or pushing the buttons. When the user moves the slider 113 to a position on the track 111, the selected amount may be determined based on the position of the slider on the track.

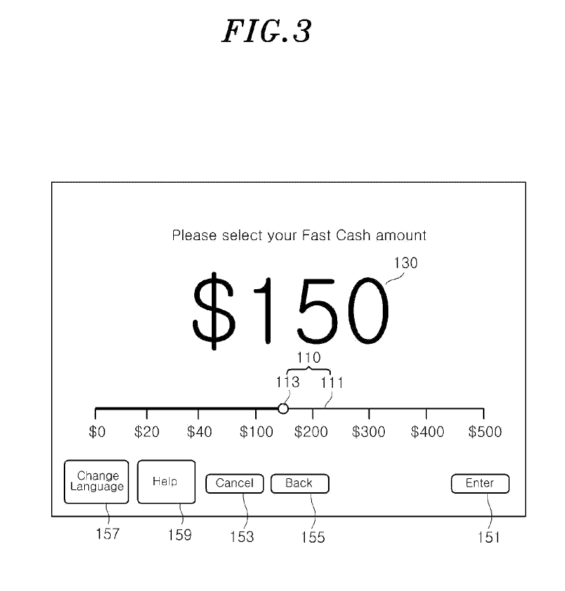

FIG. 3 describes the user interface as shown in FIG. 2, in which the slider 113 is moved and stopped at a certain position on the track 111. As shown in FIG. 3, if the slider 113 is located at the midpoint between the amount indicator corresponding to $100 and the amount indicator corresponding to $200, the selected amount may be determined as $150. In this example, if the user moves the slider 113 closer to the amount indicator $100, the selected amount may be changed and determined to be a value less than $150, and if the user moves the slider 113 closer to the amount indicator $200, the selected amount may be changed and determined to be a value more than $150.

Thereafter, the selected amount (e.g., $150) is displayed on the output unit 130. In some embodiments, the selected amount may be determined and displayed in response to the completion of the user input. In some other embodiments, however, the selected amount may be determined and displayed while the user is moving the slider 113 along the track 111. For example, the selected amount may be determined (i.e., updated) and displayed periodically, and the period of time may be adjusted such that the selected amount can be recognized by the user as changing continuously. In this way, the user selects the desired amount easily and accurately.

In determining the selected amount by the position of the slider 113 within the track 111, a selectable range of the amount may be limited by the length of the track 111. For this reason, the user may want to expand the selectable range of the amount. In accordance with one embodiment of the present invention, when the slider 113 is positioned at an end of the track 111 or a predetermined area in the vicinity of the end of the track 111, the plurality of amount indicators may be changed. For example, if the user moves the slider 113 to the right end or the predetermined area in the vicinity of the right end of the track 111 to select the amount exceeding $500, the plurality of amount indicators $0, $20, $40, $100, $200, $300, $400, $500 may be respectively changed into $20, $40, $100, $200, $300, $400, $600. Alternatively, positions of the plurality of amount indicators may be shifted to expand the selectable range of the amount. For example, while the user keeps the slider 113 at the right end of the track 111, the plurality of amount indicators and corresponding scale marks may be shifted to the left. Alternatively or additionally, a dashed line may be displayed at the right end of the track 111 or other signs may be additionally displayed in the vicinity of the right end of the track 111, so that the user may recognize that the slider 113 can be further moved to the right.

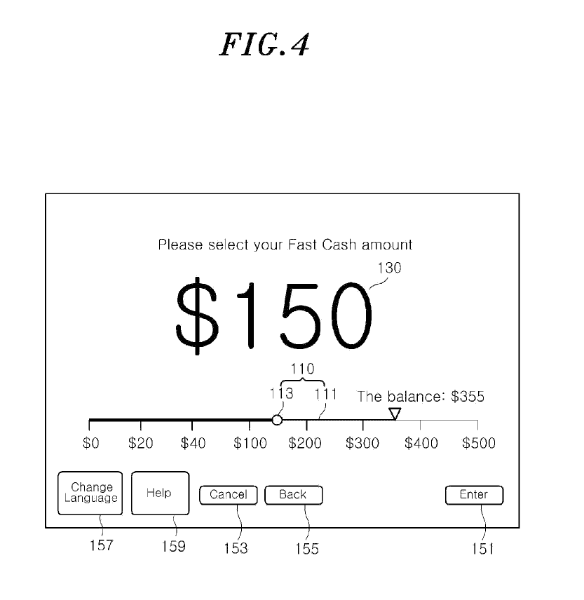

The track 111 may be divided into a movable area and an unmovable area of the slider 113 based on a transaction limit of the user. The transaction limit may include a withdrawal limit or a transfer limit of the user's account. When the user withdraws or transfers money from his account, the amount of money exceeding the withdrawal limit or the transfer limit cannot be selected by the user. The unmovable area of the slider 113 is provided for that purpose. In some embodiments, the transaction limit may be the balance of the user's account or predetermined value set by the account holder and/or a financial institution, such as a bank. For example, in FIG. 4, track 111 is divided into, based on the balance of the financial account, i.e., $355, the movable area (i.e., $0 to $355) and the unmovable area (i.e., $355 to $500). In some embodiments, the color, thickness, or texture of the unmovable area may be displayed differently from those of the movable area (For instance, the unmovable area can be greyed out.).

The user interface for use in selecting an amount to be transacted by a user of an ATM in accordance with one embodiment of the present invention may be provided in the process of a withdrawal transaction in which the user selects a withdrawal amount. In this case, the withdrawal amount should be an amount that can be withdrawn from the ATM using the denominations (i.e., currency units) handled by the ATM. Therefore, if the amount selected by the user is a certain integer multiple of the value of a smallest banknote handled by the ATM, the amount of money can be withdrawn from the ATM. However, if the amount selected by the user is not an integer multiple of the value of the smallest banknote, it cannot be withdrawn from the ATM. For example, if the value of a smallest banknote handled by the ATM is $20, the amount $150 cannot be selected since the amount $150 is not an integer multiple of the minimum withdrawable amount $20. In accordance with one embodiment of the present invention, when the selected amount is not an integer multiple of the minimum withdrawable amount from the ATM, the selected amount may be automatically adjusted to be a certain integer multiple of the minimum withdrawable amount. For example, the certain integer multiple of the minimum withdrawable amount may be an integer multiple of the minimum withdrawable amount nearest to the amount selected by the user. Further, the certain integer multiple of the minimum withdrawable amount may be an integer multiple of the minimum withdrawable amount nearest to but not less than the amount selected by the user. In addition, the slider 113 may be automatically moved on the track 111 such that the selected amount becomes an integer multiple of the minimum withdrawable amount. For example, if the selected amount determined by the position of the slider 113 is $155 and the minimum withdrawable amount is $20, slider 113 may be automatically moved on the track 111 such that the selected amount becomes $160 which is the integer multiple of $20 and the nearest to $155. If the selected amount determined by the position of the slider 113 is $150 and the minimum withdrawable amount is $20, the slider 113 may be automatically moved on the track 111 such that the selected amount becomes either one of $140 and $160 based on predetermined criteria.

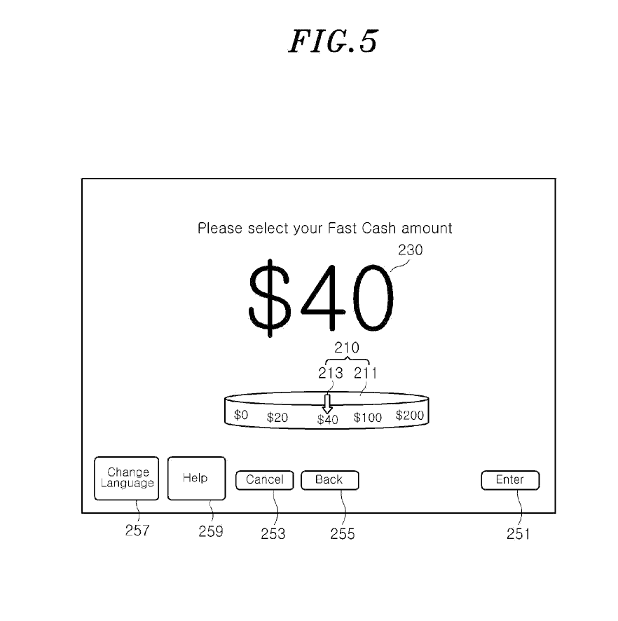

FIG. 5 shows a user interface for use in selecting an amount of money to be transacted by a user of an ATM in accordance with another embodiment of the present invention. The user interface of the ATM in accordance with this embodiment of the present invention comprises an input unit 210 and an output unit 230.

As shown in FIG. 5, the input unit 210 and the output unit 230 may be implemented as parts of a graphic user interface (GUI) displayed on a touch screen, but are not limited thereto. The input unit 210 and the output unit 230 may be respectively displayed on at least two different touch screens. Further, the input unit 210 may be displayed on a touch screen while the output unit 230 may be displayed on other means for display. Further, the input unit 210 is not limited to the graphic user interface displayed on the touch screen, but may be a separate component coupled to the ATM, such as a scroll device.

The input unit 210 receives a user input. The user input may be associated with a sliding gesture. The sliding gesture may be associated with a sliding motion of a part of a human body (e.g., the user's finger) or of other objects that are not a part of a human body (e.g., a stylus). Further, the sliding gesture may be associated with a touchless motion of the user (e.g., a hand motion) recognized by a sensor, such as a camera.

The selected amount is determined based on the user input received at the input unit 210. The selected amount is then displayed on the output unit 230

As illustrated in FIG. 5, the input unit 210 may include a rotator 211 marked with a plurality of amount indicators. In this example, the plurality of amount indicators respectively correspond to predetermined values (i.e., $0, $20, $40, $100, $200). The rotator 211 is rotated by the user input. The user input may be associated with a sliding gesture. For example, the rotator 211 may be dragged by the movement of the user's finger in contact with any position of the rotator 211. Further, other elements in the form of buttons (e.g., arrow shaped buttons) may be added such that the user can rotate the rotator 211 by touching or pushing the buttons.

The rotator 211 may be implemented in the form of a 3-dimensional structure (e.g., a cylinder) or a planar structure (e.g., a disc). Further, rotator 211 may be designed as a scroll wheel of a mouse or a volume tuner of a radio. It will be understood that the shapes described above are mere exemplary shapes of the rotator 211, and the rotator 211 may be designed as other appropriate shapes.

When the user rotates the rotator 211, the selected amount may be determined based on a degree of rotation of the rotator 211. The selected amount (e.g., $40) is displayed on the output unit 230. In some embodiments, input unit 210 may further include an indication marker 213 for indicating a certain position of the rotator 211 to facilitate accurate selection. The selected amount may be determined to be the amount indicated by the indication marker 213.

As mentioned above, the selected amount may be determined and displayed in response to the completion of the user input, but in some other embodiments, the selected amount may be determined and displayed while the user is rotating the rotator 211.

In accordance with the embodiment illustrated in FIG. 5, the rotator 211 is configured to be rotatable within a range not exceeding a transaction limit of the user. The transaction limit may include a withdrawal limit or a transfer limit of the user's account. When the user withdraws or transfers money from his account, the amount of money exceeding the withdrawal limit or the transfer limit cannot be selected by the user. Therefore, the rotator 211 is configured to be rotatable within a range not exceeding a certain limit. In some embodiments, the transaction limit of the user may be the balance of the user's account or predetermined value set by the account holder and/or a financial institution, such as a bank.

In accordance with the embodiment illustrated in FIG. 5, the user interface for use in selecting an amount to be transacted by a user of an ATM may be provided in the process of a withdrawal transaction in which the user selects a withdrawal amount. In this case, when the selected amount is not an integer multiple of the minimum amount withdrawable from the ATM, the selected amount may be automatically adjusted to be a certain integer multiple of the minimum withdrawable amount. For example, the certain integer multiple of the minimum withdrawable amount may be an integer multiple of the minimum withdrawable amount nearest to the amount selected by the user. Further, the certain integer multiple of the minimum withdrawable amount may be an integer multiple of the minimum withdrawable amount nearest to but not less than the amount selected by the user. In addition, the rotator 211 may be automatically rotated such that the selected amount becomes an integer multiple of the minimum withdrawable amount.

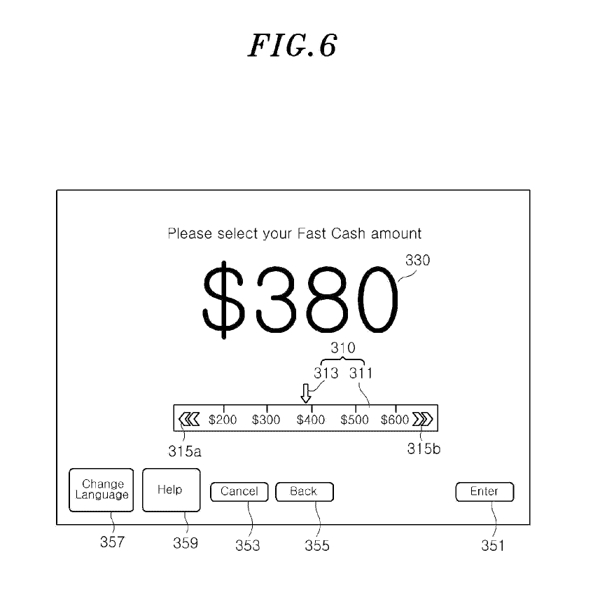

FIG. 6 illustrates a user interface for use in selecting an amount of money to be transacted by a user of an ATM in accordance with yet another embodiment of the present invention. The user interface of the ATM in accordance with this embodiment of the present invention comprises an input unit 310 and an output unit 330.

As shown in FIG. 6, the input unit 310 and the output unit 330 may be implemented as parts of a graphic user interface (GUI) displayed on a touch screen, but are not limited thereto. The input unit 310 and the output unit 330 may be respectively displayed on at least two different touch screens. Further, the input unit 310 may be displayed on a touch screen while the output unit 330 may be displayed on other means for display. Further, the input unit 310 is not limited to the graphic user interface displayed on the touch screen, but may be a separate component coupled to the ATM, such as a scroll device.

The input unit 310 receives a user input. The user input may be associated with a sliding gesture. The sliding gesture may be associated with a sliding motion of a part of a human body (e.g., the user's finger) or of other objects that are not a part of a human body (e.g., a stylus). Further, the sliding gesture may be associated with a touchless motion of the user (e.g., a hand motion) recognized by a sensor, such as a camera.

The selected amount is determined based on the user input received at the input unit 310. The selected amount is then displayed on the output unit 330

As illustrated in FIG. 6, the input unit 310 may include a tape 311 marked with a plurality of amount indicators. In this example, the plurality of amount indicators respectively correspond to predetermined values (i.e., $200, $300, $400, $500, $600). The rotator 311 is shifted by the user input. The user input may be associated with a sliding gesture. For example, the tape 311 may be dragged by the movement of the user's finger in contact with position of the tape 311. Further, other elements in the form of buttons (e.g., arrow shaped buttons) may be added such that the user can shift the tape 311 by touching or pushing the buttons.

The tape 311 may be implemented in the form of an elongated band or belt. A part of the tape 311 may be hidden at first, and the hidden part of the tape 311 may appear after the user shifts the tape 311 to either end thereof. It will be understood that the shapes described above are mere exemplary shapes of the tape 311, and the tape 311 may be designed as other appropriate shapes.

The input unit 310 may further include direction indication markers. For example, as shown in FIG. 6, if the tape 311 can be shifted both leftward and rightward, arrow markers 315a and 315b may be respectively displayed on both sides. If the tape 311 is stopped at the limit of one direction and cannot be further shifted to the direction, the arrow marker indicating the direction may disappear.

When the user shifts the tape 311, the selected amount may be determined based on a degree of shift of the tape 311. The selected amount (e.g., $380) is displayed on the output unit 330. In some embodiments, input unit 310 may further include an indication marker 313 for indicating a certain position of the tape 311 to facilitate accurate selection. The selected amount may be determined to be the amount indicated by the indication marker 313.

As mentioned above, the selected amount may be determined and displayed in response to the completion of the user input, but in some other embodiments, the selected amount may be determined and displayed while the user is shifting the tape 311.

In accordance with the embodiment illustrated in FIG. 6, the tape 311 is configured to be shiftable within a range not exceeding a transaction limit of the user. The transaction limit may include a withdrawal limit or a transfer limit of the user's account. When the user withdraws or transfers money from his account, the amount of money exceeding the withdrawal limit or the transfer limit cannot be selected by the user. Therefore, the tape 311 is configured to be rotatable within a range not exceeding a certain limit. In some embodiments, the transaction limit may be the balance of the user's account or predetermined value set by the account holder and/or a financial institution, such as a bank.

In accordance with the embodiment illustrated in FIG. 6, the user interface for use in selecting an amount to be transacted by a user of an ATM may be provided in the process of a withdrawal transaction in which the user selects a withdrawal amount. In this case, when the selected amount is not an integer multiple of the minimum amount withdrawable from the ATM, the selected amount may be automatically adjusted to be a certain integer multiple of the minimum withdrawable amount. For example, the certain integer multiple of the minimum withdrawable amount may be an integer multiple of the minimum withdrawable amount nearest to the amount selected by the user. Further, the certain integer multiple of the minimum withdrawable amount may be an integer multiple of the minimum withdrawable amount nearest to but not less than the amount selected by the user. In addition, the tape 311 may be automatically shifted such that the selected amount becomes an integer multiple of the minimum withdrawable amount.

In FIGS. 2 to 6, although the plurality of amount indicators are illustrated as values $0, $20, $40, $100, $200, and the like, such values are mere examples and the amount indicators other than the above values may be displayed. Further, the amount indicators may be set to be predetermined values regardless of the user's account, but in some embodiments, may be values calculated in accordance with predefined ratios based on a transaction limit of the user. The transaction limit may include a withdrawal limit or a transfer limit of the user's account. For example, when the user withdraws money from his account having the withdrawal limit $200, it is unnecessary to display values exceeding $200 as the amount indicators. In this case, the amount indicators may correspond to, for example, values $0, $20, $40, $60, $80, $100, $140, and $200 instead of the values $0, $20, $40, $100, $100, $200, $300, $400, and $500 as illustrated in FIG. 2.

In some embodiments, the plurality of amount indicators may be directly selectable by the user by way of pushing or touching thereof. When one of the plurality of amount indicators is selected by the user, an amount corresponding to the selected amount indicator is determined to be the selected amount and displayed on the output unit. For example, if the user touches or pushes $300 among the plurality indicators as shown in FIG. 2, the selected amount may be determined as $300. In this way, the plurality of amount indicators may be buttons to be touched or pushed, as well as indices to give information for selecting an amount.

In some embodiments, the user interface for use in selecting an amount to be transacted by a user further comprises an enter button 151, 251 or 351 for the user's final confirmation. For example, if the selected amount is finally confirmed by the user during a withdrawal transaction, the selected amount of money may be withdrawn from the user's account. If the selected amount is finally confirmed by the user during a transfer transaction, the selected amount of money may be transferred from the user's account. Alternatively, the user may make a final confirmation in a different way without pushing or touching the enter button. For example and not as a limitation, in FIG. 1, the user may make a final confirmation by touching the slider 113 once again after dragging it.

In some embodiments, the user interface for use in selecting an amount to be transacted by a user further comprises a cancel button 153, 253 or 353 for canceling the selected amount. For example, if the user selects the cancel button 153 of FIG. 5 when the selected amount is displayed as $150, the selected amount may be changed to $0 as illustrated in FIG. 4.

In some embodiments, the user interface for use in selecting an amount to be transacted by a user further comprises a back button 155, 255 or 355 for returning to the previous stage. For example, if the user who wants to transfer money selects a withdrawal transaction by mistake, the user may select the back button to return to the previous stage.

In some embodiments, the user interface for use in selecting an amount to be transacted by a user further comprises a change language button 157, 257 or 357 for changing the language used in the user interface. For example, although explanations and buttons in the embodiments illustrated in FIGS. 2 to 6 are expressed in English, the user may select the change language button 157, 257 or 357 to change the language into any language other than English.

In some embodiments, the user interface for use in selecting an amount to be transacted by a user further comprises a help button 159, 259 or 359. In the process of carrying out a transaction at the ATM, the user may select the help button 159, 259 or 359 to be assisted by a teller over the telephone or the video telephone. Alternatively or additionally, the help button 159, 259 or 359 may operate like a staff call button for calling the teller near the ATM in use.

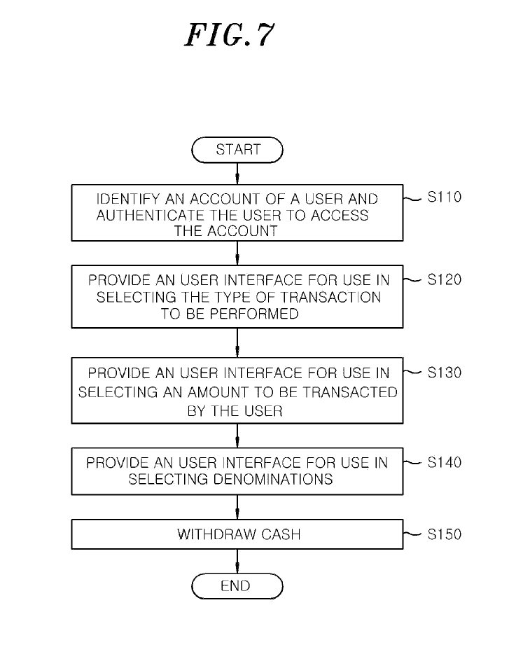

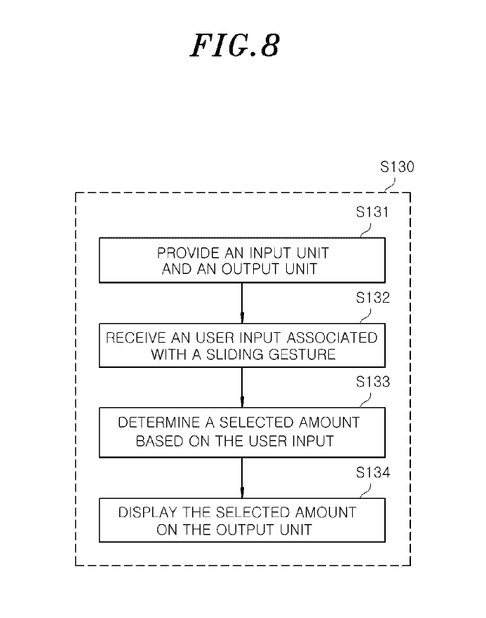

Hereinafter, a method for providing a user interface for use in selecting an amount to be transacted by a user will be explained in accordance with embodiments of the present invention with reference to FIGS. 7 and 8.

FIG. 7 presents a flow diagram describing an exemplary process of withdrawing cash by using an ATM in accordance with an embodiment of the present invention. Although the withdrawal transaction will be described referring to FIG. 7, user interfaces of embodiments may also be provided in association with other types of transactions, such as transfer transaction.

At step S110, the account of the user is identified and the user is authenticated to access the account by the ATM. For example, identification of the account of the user and the authentication of the user may be performed by inserting a card into the ATM and inputting a personal identification number (PIN) therefor. In this way, the user's account associated with the card can be determined, and whether or not to allow the user to perform a transaction for the account can be decided. The user may also insert a bankbook or directly input an account number to the ATM. It will be understood that these are mere examples and other appropriate techniques can be employed for identification of the account and the authentication of the user.

Transitioning to step S120, the user interface for use in selecting the type of transaction to be performed is provided. By using the user interface, the user may select a transaction to be performed for financial account. For example, the user may select any types of financial transactions including deposit, withdrawal, transfer, balance inquiry, and the like. The withdrawal transaction may be divided into normal withdrawal and fast withdrawal. For example, the normal withdrawal provides a conventional withdrawal user interface while the fast withdrawal provides a simplified user interface in accordance with an embodiment of the present invention. In some embodiments, the withdrawal transaction, of course, may have only one mode.

When a withdrawal transaction is selected by the user, flowing to step S130, the user interface in accordance with an embodiment of the present invention is presented. The user interface for use in selecting an amount is described above. The method for providing the user interface will be described in detail referring to FIG. 8.

When the user selects an amount to be transacted, flowing to step S140, a user interface for use in selecting denominations is provided. In this user interface, the user may select denominations for withdrawal.

Transitioning to step S150, cash can be withdrawn based on the selected amount and the selected denominations.

So far, referring to FIG. 7, the exemplary process for cash withdrawal from the ATM in accordance with an embodiment of the present invention is described. It will be understood that modifications can be made to the described embodiment. For example, step S140 may be omitted. If step S140 is omitted, denominations may be selected based on predefined criteria without the user's selection. Further, before step S150, a user interface for use in determining whether to print a receipt may be provided.

FIG. 8 is a flow diagram illustrating an exemplary method for providing a user interface for use in selecting an amount to be transacted by a user of an ATM in accordance with an embodiment of the present invention. The exemplary flow diagram illustrated in FIG. 8 may replace step S130 of FIG. 7.

At step S131, an input unit and an output unit are provided. As noted above, the input unit and the output unit may be implemented as parts of a graphic user interface (GUI) displayed on a touch screen, but is not limited therein to.

Transitioning to step S132, a user input is received at the input unit. The user input may be associated with a sliding gesture. The sliding gesture may be associated with a sliding motion of a part of a human body (e.g., the user's finger) or of other objects that are not a part of a human body (e.g., a stylus). Further, the sliding gesture may be associated with a touchless motion of the user (e.g., a hand motion) recognized by a sensor, such as a camera.

Transitioning to step S133, the selected amount is determined based on the user input. The determination criteria may differ depending on the various types of input units (e.g., as described above, the input unit including the track and the slider, the input unit including the rotator, and the input unit including the tape, and the like).

Transitioning to step S134, the selected amount is displayed on the output unit. In some embodiments, the selected amount may be determined and displayed in response to the completion of the user input. In some other embodiments, the selected amount may be determined and displayed while the user is making a selection.

Embodiments of the present invention comprise non-transitory computer-readable recording media including program instructions to implement various operations implemented by a computer. The computer-readable recording media may also include program instructions, data files, data structures, or combination thereof. The media or the program instructions may be designed particularly for the embodiments of the present invention, or commonly available for those skilled in the art. Examples of computer readable media include magnetic media (e.g., hard disks, floppy disks, and magnetic tapes), optical media (e.g., CD-ROMs and DVDs), magneto-optical media (e.g., floptical discs), and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described hardware devices may be configured to act as one or more software modules in order to perform the operations of the above-described embodiments of the present invention, or vice versa.

Although the invention has been shown and described with respect to the embodiments, it will be understood by those skilled in the art that various changes and modifications may be made without departing from the spirit and scope of the claimed subject matter.

What is claimed is:

1. An apparatus for providing a user interface for use in selecting an amount to be transacted by a user of an automated teller machine (ATM), the user interface comprising:
an input unit for receiving a user input associated with a sliding gesture; and
an output unit for displaying a selected amount determined based on the user input associated with the sliding gesture.

2. The apparatus according to claim 1, wherein
the input unit includes a track marked with a plurality of amount indicators and a slider movable along the track by the user input associated with the sliding gesture; and
the selected amount is determined based on a position of the slider on the track.

3. The apparatus according to claim 1, wherein
the input unit includes a rotator marked with a plurality of amount indicators, the rotator being rotated by the user input associated with the sliding gesture; and
the selected amount is determined based on a degree of rotation of the rotator.

4. The apparatus according to claim 1, wherein
the input unit includes a tape marked with a plurality of amount indicators, the tape being shifted by the user input associated with the sliding gesture; and
the selected amount is determined based on a degree of shift of the tape.

5. The apparatus according to claim 2, wherein
the input unit is implemented as a part of a graphic user interface displayed on a touch screen; and
when the slider is positioned at an end of the track or a predetermined area in the vicinity of the end of the track, the plurality of amount indicators are changed or positions of the plurality of amount indicators are shifted to expand a selectable range of the amount.

6. The apparatus according to claim 2, wherein
the input unit is implemented as a part of a graphic user interface displayed on a touch screen; and
the track is divided into a movable area and an unmovable area of the slider based on a transaction limit of the user.

7. The apparatus according to claim 2, wherein
the input unit is implemented as a part of a graphic user interface displayed on a touch screen; and
when the selected amount is associated with withdrawal and the selected amount is not an integer multiple of minimum withdrawable amount from the ATM, the slider is automatically moved such that the selected amount becomes an integer multiple of the minimum withdrawable amount that is nearest to the amount selected by the user.

8. The apparatus according to claim 3, wherein
the input unit is implemented as a part of a graphic user interface displayed on a touch screen; and
the rotator is configured to be rotatable within a range not exceeding a transaction limit of the user.

9. The apparatus according to claim 3, wherein
the input unit is implemented as a part of a graphic user interface displayed on a touch screen; and
when the selected amount is associated with withdrawal and the selected amount is not an integer multiple of a minimum withdrawable amount from the ATM, the rotator is automatically rotated such that the selected amount becomes an integer multiple of the minimum withdrawable amount that is nearest to the amount selected by the user.

10. The apparatus according to claim 4, wherein
the input unit is implemented as a part of a graphic user interface displayed on a touch screen; and
the tape is configured to be shiftable within a range not exceeding a transaction limit of the user.

11. The apparatus according to claim 4, wherein
the input unit is implemented as a part of a graphic user interface displayed on a touch screen; and
when the selected amount is associated with withdrawal and the selected amount is not an integer multiple of a minimum withdrawable amount from the ATM, the tape is automatically shifted such that the selected amount becomes an integer multiple of the minimum withdrawable amount that is nearest to the amount selected by the user.

12. The apparatus according to claim 2, wherein
the input unit is implemented as a part of a graphic user interface displayed on a touch screen; and
the plurality of amount indicators are displayed as values calculated in accordance with predefined ratios based on a transaction limit of the user.

13. The apparatus according to claim 2, wherein
each of the plurality of amount indicators is directly selectable by the user; and
when one of the plurality of amount indicators is selected, an amount corresponding to the selected amount indicator is determined to be the selected amount and displayed on the output unit.

14. A method for providing a user interface for use in selecting an amount to be transacted by a user of an automated teller machine (ATM), the method comprising the steps of:
providing an input unit and an output unit;
receiving, by the input unit, a user input associated with a sliding gesture;
determining a selected amount based on the user input associated with the sliding gesture; and
displaying the selected amount on the output unit.

15. The method according to claim 14, wherein
the input unit includes a track marked with a plurality of amount indicators and a slider movable along the track by the user input associated with the sliding gesture; and
the selected amount is determined based on a position of the slider on the track.

16. The method according to claim 14, wherein
the input unit includes a rotator marked with a plurality of amount indicators, the rotator being rotated by the user input associated with the sliding gesture; and
the selected amount being determined based on a degree of rotation of the rotator.

17. The method according to claim 14, wherein
the input unit includes a tape marked with a plurality of amount indicators, the tape being shifted by the user input associated with the sliding gesture; and
the selected amount being determined based on a degree of shift of the tape.
